(19) United States
(12) Patent Application Publication
(10) Pub. No.: US 2006/0245359 A1
(43) Pub. Date: Nov. 2, 2006

(54) Processor overload control for network nodes

(75) Inventor: Patrick Hosein, San Diego, CA (US)

Correspondence Address: COATS & BENNETT, PLLC, P O BOX 5, RALEIGH, NC, 27602, US

(73) Assignee: Telefonaktiebolaget LM Ericsson (publ)

(21) Appl. No.: 11/118,676

(22) Filed: Apr. 29, 2005

(51) Int. Cl. H04J 1/16

(52) U.S. Cl. 370/235

(57) ABSTRACT

A method and apparatus is disclosed for preventing excessive loading at a network node. The admitted load into the network node is monitored by a load detector. The load detector generates a load indication that is passed to a load controller. The load controller detects an overload condition based on the load indication and computes a message admission criteria for admitting new messages when an overload condition is detected. An admission controller throttles incoming message streams such that the ratio of admitted messages to offered messages satisfies the admission criteria provided by the load controller.

### BACKGROUND OF THE INVENTION

The present invention relates generally to mobile communication networks and more particularly to an overload controller to prevent excessive loading in network nodes within the network.

In a wireless communication network, excessive processing loads at a network node within the network may lead to system crashes and, consequently, loss of system capacity. To avoid these problems, overload controls are employed to prevent excessive loading at network nodes. In general, overload controls should be rarely used and are intended primarily to avoid system collapse during rare overload events. Frequent activation of overload controls indicates that system capacity is insufficient and should be increased.

Overload controls are difficult to develop and test in a lab setting because extremely high offered loads must be generated and a wide range of operating scenarios must be covered. Also, because overload controls are meant to be activated infrequently in the field, undetected bugs may not show up for several months after deployment. These factors suggest the need to emphasize control robustness over system performance in the design of overload controls. In general, it is less costly to improve control robustness while maintaining adequate performance than it is to extract the last few ounces of system performance while maintaining adequate robustness.

### SUMMARY OF THE INVENTION

The present invention is related to a method and apparatus for controlling the flow of incoming messages to a processor. A message throttler uses fractional tokens and controls the admission rate for incoming messages such the admission rate is proportional to the rate of incoming messages. Upon the arrival of an incoming message, the message throttler increments a token count by a fractional amount to compute a new token count, compares the new token count to a threshold, and admits a message from a message queue if the new token count satisfies a threshold. In one embodiment, the fractional amount of the tokens is dependent on the processing load.

The present invention may be employed to provide overload control in a network node in a communication network. A load detector monitors one or more processors located at the network node and generates a load indication. In one embodiment, the load indication is a filtered load estimate indicative of the load on the busiest processor located at the network node. The load indication is provided to a load controller. The load controller detects an overload condition and, when an overload condition exists, computes a message admission criteria based on the load indication. The message admission criteria may comprise, for example, an admission percentage expressed as a fraction indicating a desired percentage of the incoming messages that should be admitted into the network node. An admission controller including one or more message throttlers controls the admission of new messages into the network node based on the admission percentage provided by the admission controller, i.e., throttles incoming message streams.

In one embodiment, the admission percentage is applied across all message streams input into the network node. In other embodiments, the admission percentage may be applied only to those message streams providing input to the overloaded processor. When an overload condition exists, the load controller periodically computes the admission percentage and provides the admission percentage periodically to the admission controller. When the overload condition dissipates, the load controller signals the admission controller to stop throttling the incoming messages.

### BRIEF DESCRIPTION OF THE DRAWINGS

FIG. 1 is a functional block diagram of an exemplary wireless communication network.

FIG. 2 is a block diagram of a generic network mode for processing messages in a wireless network.

FIG. 2A is a block diagram of a message throttler.

FIG. 3 is a flow chart illustrating the operation of an exemplary load detector.

FIG. 4 is a flow chart illustrating the operation of an exemplary load controller.

FIG. 5 is a flow chart illustrating the operation of an exemplary admission controller.

### DETAILED DESCRIPTION OF THE INVENTION

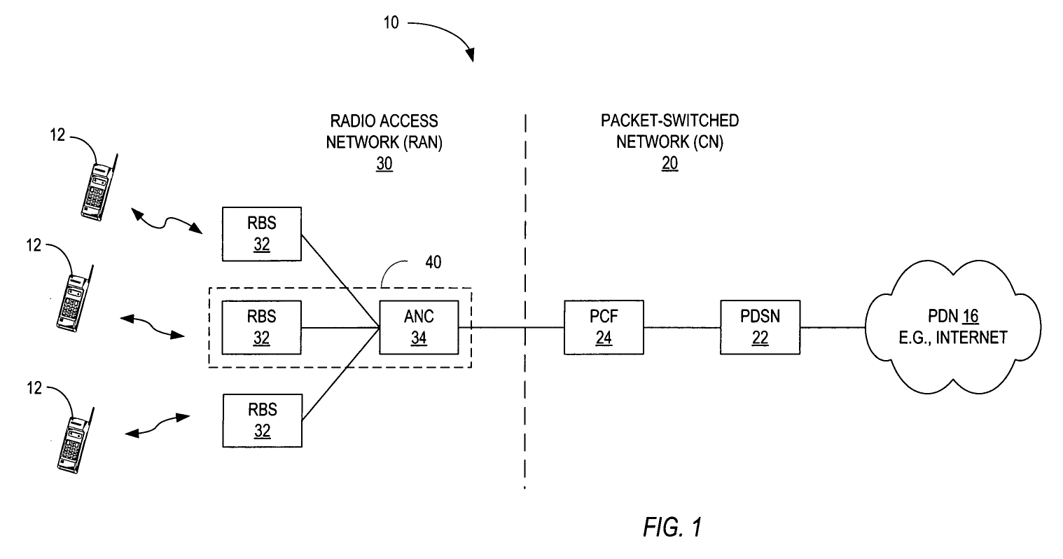

FIG. 1 illustrates an exemplary communication network indicated generally by the numeral 10. FIG. 1 illustrates a wireless communication network 10 configured according to the IS-856 standard, commonly known as 1x-EV-DO. Other standards, including IS-2000 (also known as 1xEV-DV) and Wideband CDMA (W-CDMA), could also be implemented by the network 10. The present invention could also be employed in fixed, rather than wireless, networks.

The wireless communication network 10 is a packet-switched network that employs a high-speed forward packet data channel (F-PDCH) to transmit data to the mobile stations 12. Wireless communication network 10 comprises a packet-switched network 20 including a Packet Data Serving Node (PDSN) 22, and Packet Control Function (PCF) 24, and one or more access networks (ANs) 30. The PDSN 22 connects to an external packet data network (PDN) 16, such as the Internet, and supports PPP connections to and from the mobile station 12. The PDSN 22 adds and removes IP streams to and from the ANs 30 and routes packets between the external packet data network 16 and the ANs 30. The PCF 14 establishes, maintains, and terminates connections from the AN 30 to the PDSN 22.

The ANs 30 provide the connection between the mobile stations 12 and the packet switched network 20. The ANs 30 comprise one or more radio base stations (RBSs) 32 and an access network controller (ANC) 34. The RBSs 32 include the radio equipment for communicating over the air interface with mobile stations 12. The ANC 34 manages radio resources within their respective coverage areas. An ANC 34 can manage more than one RBSs 32. In cdma2000 networks, an RBS 32 and an ANC 34 comprise a base station 40. The RBS 32 is the part of the base station 40 that includes the radio equipment and is normally associated with a cell site. The ANC 34 is the control part of the base station 40. In cdma2000 networks, a single ANC 34 may comprise the control part of multiple base stations 40. In other network architectures based on other standards, the network components comprising the base station 40 may be different but the overall functionality will be the same or similar.

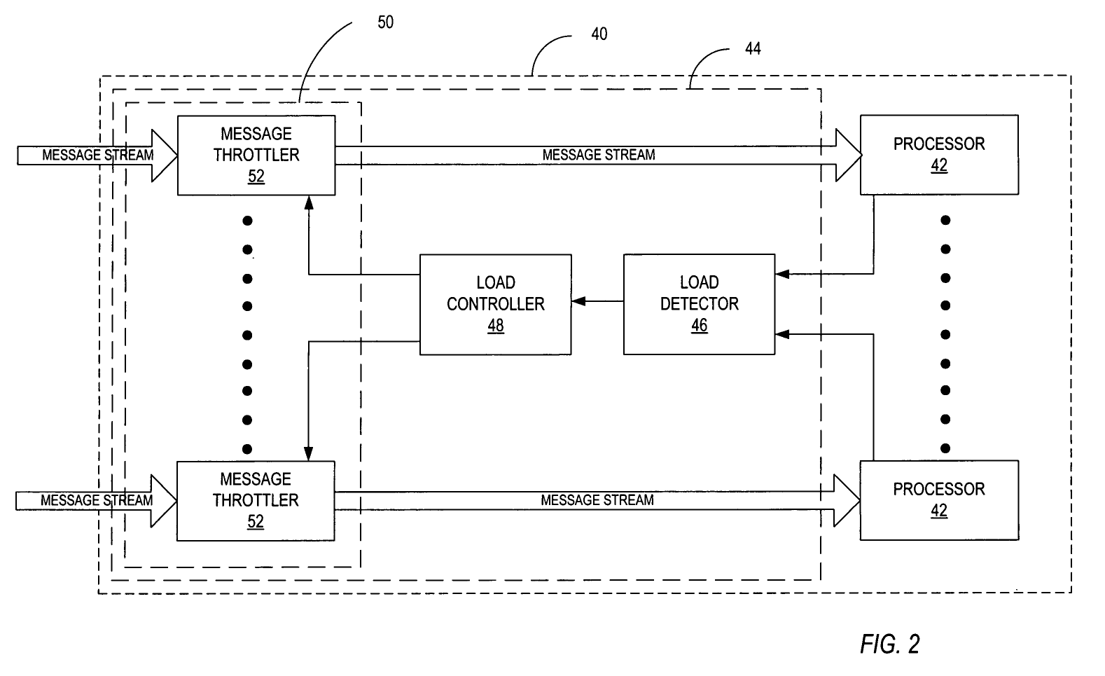

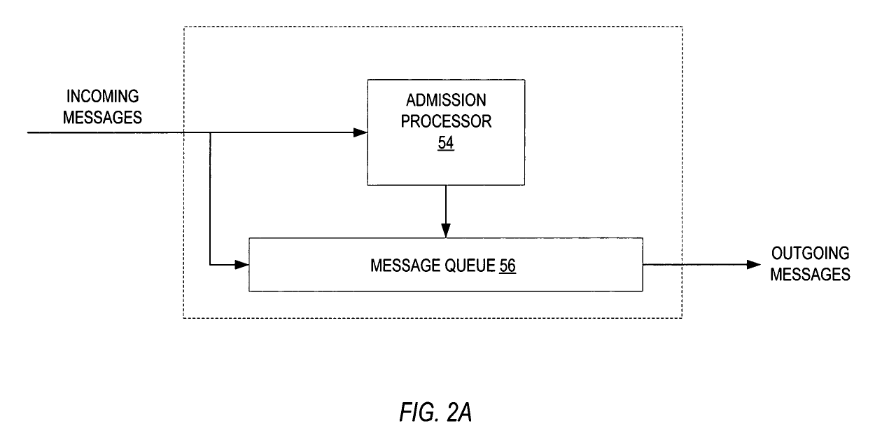

Each network node (e.g. RBS 32, ANC 34, PDSN 22, PCF 24, etc.) within the wireless communication network 10 may be viewed as a black box with M message streams as input. The network node 40 can be any component in the wireless communication network 10 for processing messages. The message streams can be from a mobile station 12 (e.g., registration messages) or the network 10 (e.g., paging messages). A generic network node denoted by reference numeral 40 is shown schematically in FIG. 2. The network node 40 includes one or more processors 42 to process messages contained in the input message streams. When a network node 40 becomes overloaded, essential tasks may not be performed timely. If the overload condition persists, it can lead to system crashes and consequently loss of system capacity. The exemplary network node shown in FIG. 2 includes an input controller 44 to control the flow of messages into the network node 40 and thus avoid system crashes and other problems associated with processor overload. The input controller 44 comprises a load detector 46 to detect the load on a processor, a load controller 48 to adjust an admission criteria responsive to detection of an overload condition, and an admission controller 50 to control admission of new messages to the network node 40 based on the admission criteria.

The load detector 46 monitors the load on all processors 42 and reports a maximum load to the load controller 48. One measure of the load is the utilization percentage. Each processor 42 is either doing work or is idle because no work is queued. The kernel for each processor 42 measures the load by sampling the processor 42 and determining the percentage of time it is active. Denoting each processor 42 with the subscript i, a load estimate γᵢ for each processor 42 is filtered by the load detector 46 to produce a filtered load estimate \hat{ρ}ᵢ. In the discussion below, the processor 42 with the maximum estimated load is denoted i*. The time constant of the load estimate filter should be roughly equal to the average inter-arrival time of messages from the stream that creates the most work for the particular processor 42. The load reporting period should be chosen based on an appropriate tradeoff between signaling overhead and overload reaction time. The time constant and the load reporting period can be determined in advance based on lab measurements. The load reporting periods for each processor 42 should preferably be uncorrelated in order to avoid bursty processing by the load detector 46.

At any point in time the network node 40 is in one of two states, normal or overloaded. In the normal state, the estimated load \hat{ρ}ᵢ for each processor 42 is less than a predetermined threshold ρₘₐₓ and the admitted load for each processor 42 equals the offered load. The network node 40 is in the overloaded state when the processing load for one or more processors 42 exceeds the threshold ρₘₐₓ. The network node 40 remains in the overloaded state until: 1) the maximum load for all processors 42 drops below the threshold ρₘₐₓ, and 2) the admitted load equals the offered load for all processors 42.

The load detector 46 reports the maximum estimated load \hat{ρ}_{i*} among all processors 42 to the load controller 48. The load controller 48 determines the percentage of incoming messages that should be admitted to the network node 40 to maintain the maximum estimated load \hat{ρ}_{i*} below the threshold ρₘₐₓ. The percentage of incoming messages that are admitted is referred to herein as the admission percentage and is expressed in the subsequent equations as a fraction (e.g. 0.5=50%). The admission percentage is denoted herein as α(n), where n designates the control period. Note, that the control period may be a fixed period or a variable period. The admission controller 50, responsive to the load controller 48, manages the inflow of new messages into the network node 40 to maintain the admission percentage α(n) at the desired level. The admission percentage α(n) is continuously updated by the load controller 48 from one control period to the next while the overload condition persists.

Consider the instant when the network node 40 first enters an overloaded state. Assume that there M different message streams denoted by the subscript j. The message arrival rate for each message stream may be denoted by λⱼ and the average processing time for all messages may be denoted s_{i*j}. The maximum estimated load \hat{ρ}_{i*}(0) for the busiest processor 42 at the start of the first control period is given by:

$${\hat{ρ}}_{i *} ( 0 ) = {ρ}_{bkg} + {\sum }_{j = 1}^{M} {λ}_{j} {s}_{i * j} \qquad ( 1 )$$

where ρ_{bkg} represents the load generated internally by operating system management processes in the processor 42. It is assumed that ρ_{bkg} is a constant value and is the same for all processors 42. The admission percentage α(1) for the first control period in the overload event needed to make the expected processing load equal to ρₘₐₓ satisfies the equation:

$${ρ}_{max} = {ρ}_{bkg} + {\sum }_{j = 1}^{M} α ( 1 ) {λ}_{j} {s}_{i * j} \qquad ( 2 )$$

Solving Equations (1) and (2), the admission percentage α(1) for the first control period in the overload event can be computed according to:

$$α ( 1 ) = \frac{{ρ}_{max} - {ρ}_{bkg}}{{\hat{ρ}}_{i *} ( 0 ) - {ρ}_{bkg}} \qquad ( 3 )$$

The admission percentage α(1) is reported to the admission controller 50, which throttles incoming messages in each message stream. The admission controller 50 may throttle all incoming message streams, or may throttle only those message streams providing input to the overloaded processor 42.

In the second control period of an overload event, it may be assumed that the message arrival rate for each message stream is reduced to α(1)λⱼ through the first control period. Therefore, the admission percentage α(2) for the second control period is given by:

$$α ( 2 ) = α ( 1 ) \frac{{ρ}_{max} - {ρ}_{bkg}}{{\hat{ρ}}_{i *} ( 1 ) - {ρ}_{bkg}} \qquad ( 4 )$$

In general, the admission percentage for a given control period is given by:

$$α ( n + 1 ) = α ( n ) \frac{{ρ}_{max} - {ρ}_{bkg}}{{\hat{ρ}}_{i *} ( n ) - {ρ}_{bkg}} \qquad ( 5 )$$

For the first control period in an overload event, α(1) may be assumed to be 1. Once the filtered load estimate \hat{ρ}_{i*}(n) for the busiest processor 42 is close to ρₘₐₓ, the load controller 48 maintains the same admission percentage. If the filtered load estimate \hat{ρ}_{i*}(n) is smaller than ρₘₐₓ the admitted load is increased, while if it is larger than ρₘₐₓ, the admitted load is decreased. The network node 40 is no longer in an overloaded state once the admission percentage α(n) becomes larger than unity.

Note that an overload event is triggered when the maximum estimated load \hat{ρ}_{i*}(n) exceeds ρₘₐₓ for the busiest processor 42. However, the overload control algorithm continues to be active even if the maximum load drops below ρₘₐₓ. The reason is that a drop in load does not necessarily indicate reduction in the offered load to the network node 40, but may be due to a reduction in the admitted load. Hence, once overload control is triggered, the maximum estimated load \hat{ρ}_{i*}(t) cannot be used to determine overload dissipation.

As \hat{ρ}_{i*}(n) drops below ρₘₐₓ, α(n) increases. If \hat{p}_{i*}(n) remains below ρₘₐₓ even when α(n) is greater than unity, the network node 40 is no longer in an overload state since the admitted load equals the offered load without any processors 42 exceeding the load threshold ρₘₐₓ. Hence, dissipation of the overload condition is detected by monitoring α(n).

As noted above, the load controller 48 periodically reports the admission percentage α(n) to the admission controller 50. The admission controller 50 includes a message throttler 52 for each message stream an exemplary message throttler is shown in FIG. 2A. Each message throttler comprises an admission processor and a message queue 56 and is responsible for providing an admitted rate of α(n)λ where λ is the incoming message rate. That is, the admitted rate is proportional to the incoming message rate. Admission control or message throttling begins when the admission controller 50 receives α(1), which is an indication of an overload event. For each message arriving into a message queue of buffer (we assume a large fixed size buffer for each message stream) a token count B is incremented. Upon the arrival of an incoming message, a current token value is added to the current token count to compute a new token count. The token value in one embodiment is equal to the admission percentage α(n), which may be a fractional value. The token count B is initially set to a predetermined value, e.g. zero. If at any time a message is in the message queue and the token count B>1, a message in the message queue is admitted and the token count B is decremented by 1. Therefore a message gets served if it enters an empty buffer and the token count B>1 when it arrives into the buffer, or if the message is at the head of the buffer when a new message arrives causing the token count B to become greater than 1. Note that with and initial value of B>0, the flow is gradually reduced to the controlled rate (approaching it from above). With an initial value of B<0, the flow is initially shut-off completely and then increases gradually to the controlled rate (approaching it from below).

During a control period with a duration T, an average of λT messages arrive which causes B to increase by α(n)λT. Hence, the number of messages served equals the floor of α(n)λT. Hence the admitted rate is α(n) times the offered rate λ as required by the load controller 48. Message throttling is terminated when α(n)>1 for a predetermined number of consecutive periods. An admission percentage greater than unity implies that there is no throttling. In some embodiments, the message throttler 52 may modify α(n) based on message type. The admission percentage α(n) may be increased for higher priority messages and lowered for low priority messages.

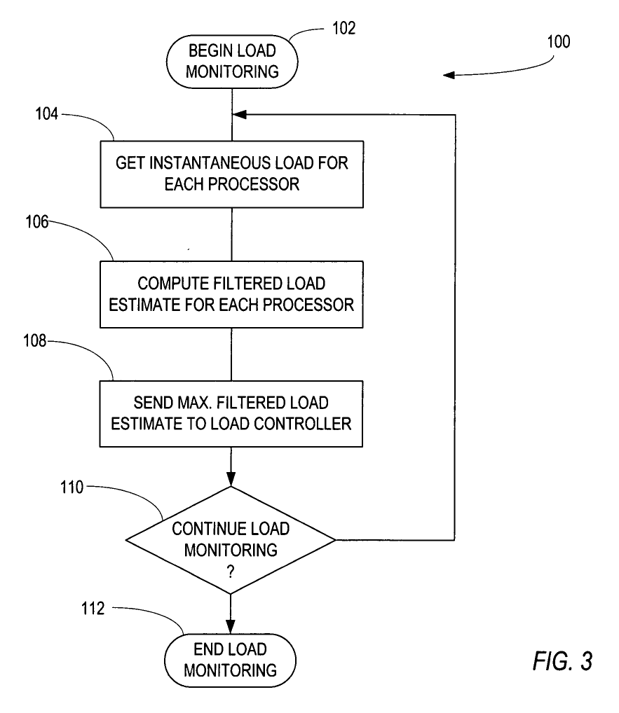

FIG. 3 illustrates an exemplary load detection function 100 to perform load monitoring for one or more processors 42 in a network node 40. When load monitoring begins (block 102), the load detector 46 periodically gets the instantaneous load for each processors (block 104), computes a filtered load estimate for each processor 42 (block 106), and sends the maximum filtered load estimate from among all processors 42 to the load controller 48 (block 108). After reporting the maximum filtered load estimate to the load controller 48, the load detector 46 determines whether to continue load monitoring (block 110). As long as load control is desired, the load detector 46 periodically repeats blocks 104 through 108 at a predetermined reporting interval. When load control is no longer needed or desired, the load monitoring may be terminated (block 112).

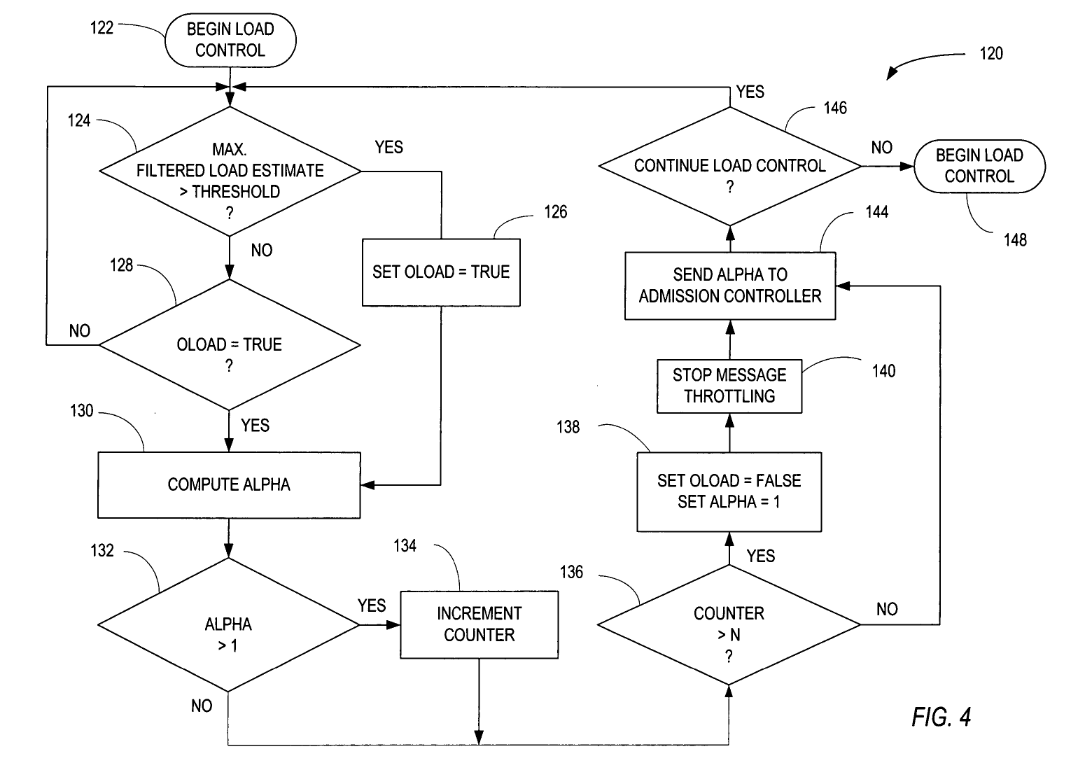

FIG. 4 illustrates an exemplary load control function 120 that may be implemented by the load controller 48. The load control function 120 may be initiated (block 122) by a system controller with a network node 40. The load controller 48 compares the maximum filtered load estimate supplied by the load detector 46 to the load threshold ρₘₐₓ (block 124). If the maximum filtered load estimate exceeds the threshold, the load controller 48 sets an overload flag (denoted oload) equal to true (block 126) and computes an admission percentage denoted as alpha (block 130) in the flow chart according to Eq. 5. If the filtered load estimate is less than the threshold (block 124), the load controller 48 checks the state of the overload flag (block 128). If the overload flag is true, indicating that the network node 40 is in an overloaded state, the load controller 48 computes an admission percentage according to Eq. 5 (block 130). If the overload flag is set to false (block 128), the load controller 48 waits for the next report from the load detector 46. The admission percentage computed by the load controller 48 is used to control or throttle the inflow of new messages into the network node 40.

The admission percentage is also used to detect the dissipation of an overload condition. The load controller 48 compares the admission percentage to 1 (block 132). An admission percentage equal to or greater than 1 implies no message throttling. If the admission percentage is greater than 1, the load controller 48 increments a counter (block 134). The load controller 48 compares the counter value to a predetermined number N (block 136). When the counter value reaches N, the network node 40 is considered to be in a normal, non-overloaded state. In this case, the load controller 48 sets the overload flag to false (block 138), sets alpha equal to 1 (block 138), and signals the admission controller 150 to stop message throttling (block 140). After checking the counter and performing any required housekeeping functions, the load controller 48 sends the admission percentage to the admission controller 50 (block 144) and determines whether to continue load controller (block 146). Normally, load control is performed continuously while the network node 40 is processing messages. In the event that load control is no longer desired or needed, the procedure ends (block 148).

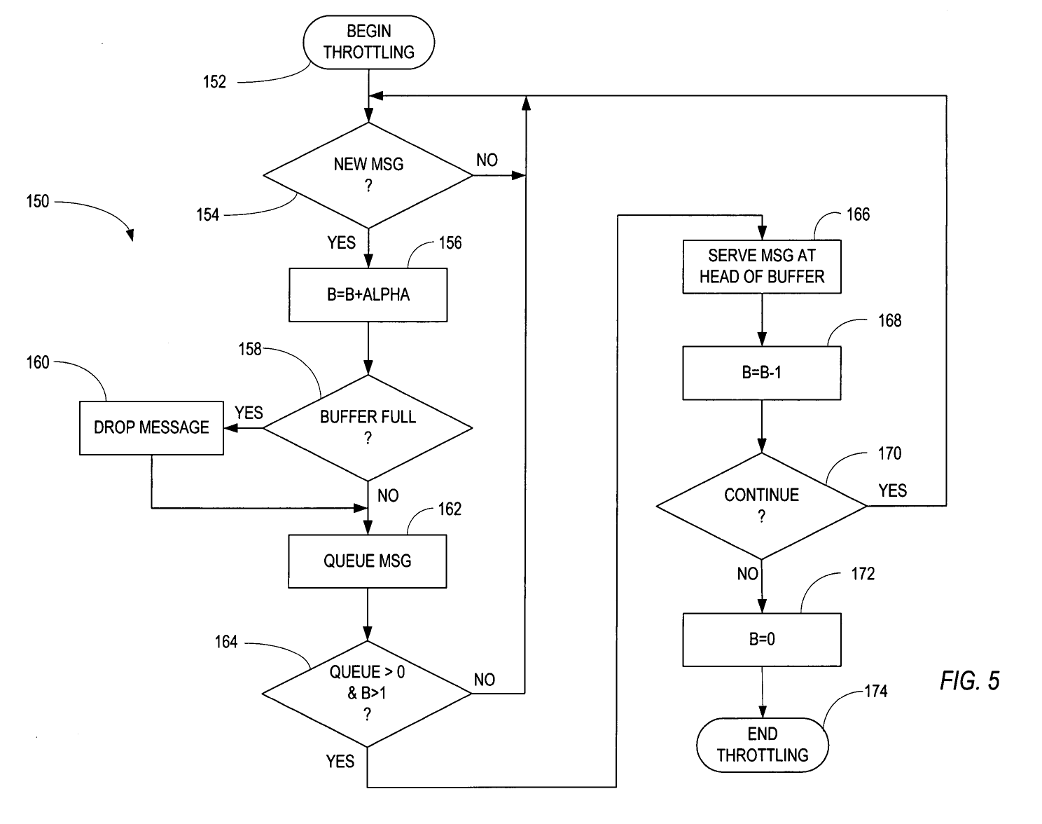

FIG. 5 illustrates an exemplary message throttling function 150 performed by a message throttler 52. The load controller 48 signals the admission controller 50 to begin message throttling (block 152). Once message throttling begins, the message throttler 52 for each message stream performs the functions shown in FIG. 5. The message throttler 52 waits for a new message to arrive (block 154). Once a new message arrives, the message throttler 52 updates a token counter B by adding the admission percentage to the current counter value (block 156). The message throttler 52 then determines whether the corresponding buffer for the message stream is full (block 158). If the buffer is full, the message is dropped (block 160). Otherwise, the message is placed into the queue (block 162). The message throttler 52 examines the queue level and the counter value (block 164). If the queue is not empty and the counter value is greater than 1, the message throttler 52 admits the message at the head of the buffer (block 166). Otherwise, the message throttler 52 waits for a new message to arrive. After serving a message (block 166), the message throttler 52 decrements the counter value B by 1 (block 168) and determines whether to continue message throttling (block 170). When message throttling is no longer needed or desired, the load controller 48 will signal the admission controller 50 to stop message throttling, the counter value B is reset to a predetermined value (e.g. B=0)(block 172), and the procedure ends (block 174). As long as the overload condition persists, the message throttling will continue. The process shown in FIG. 5 will be repeated until the overload condition dissipates.

When the processing time per message is small compared to the control interval the admission control can quickly reduce congestion. However, in some cases (e.g. T&E log collection), a single message (to turn on collection of the logs) can result in significant work on all processors 42. In such a case, it may be desirable to pre-empt such tasks. In other words, if an overloaded condition is detected, non-essential tasks should be terminated or at least the operator should be warned that user traffic will be affected if the task is not terminated.

If such non-essential tasks are not terminated, the overload control algorithm described above is still effective in protecting against overload as shown in the following example. Assume ρₘₐₓ=80 and that the average utilization of the busiest processor is 70%. Also assume that background processing tasks consume 10% of processor cycles. Now suppose that some task is started that uses 20% of the processor cycles. This work is not reduced by throttling the usual messages and hence is uncontrollable. If the above algorithm is used, the admission percentage α(1) for the first control period in an overload that α(1)=(80−10)/(90−10)=⅞. The filtered load estimate at the beginning of the first control period is \hat{ρ}(1)=30+(⅞)*60=82.5 since only 60% of the load on the busiest processor 42 is controlled and not the 80% based on our estimate of the background work. At the end of the second control interval, these calculations can be repeat to obtain α(2)=0.84483 and \hat{ρ}(2)=80.7. Therefore, within two control periods, the overload control brings the utilization of the busiest processor within 1% of its target value even though the assumption on the background work was incorrect. Note that the actual admitted load is less than that computed here since only an integer number of messages are accepted (the floor of αλT). Therefore the processor utilization is reduced faster in practice.

A similar reasoning can be used to show that, the overload control works well even if the background processing load ρ_{bkg} is different for different processors 42 and we simply use an average value in the algorithm (as opposed to using the value that corresponds to the busiest processor 42). If the background processing load of the busiest processor 42 is less than the average over all processors 42, the algorithm converges to the target threshold from below.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of controlling the admission of messages to a processor comprising:
adding a fractional token to a current token count to compute a new token count responsive to arrival of an incoming message at a message queue; and
admitting an outgoing message from the message queue in response to said arrival of said incoming message if the new token count satisfies a threshold.

2. The method of claim 1 further comprising decrementing the token count when an outgoing message is admitted.

3. The method of claim 1 wherein the fractional token has a variable value dependent on an indicated load of the processor.

4. The method of claim 3 further comprising computing a desired admission percentage based on the indicated load, and determining the value of said fractional token based on the desired admission percentage.

5. The method of claim 4 wherein the value of the fractional token equals the admission percentage.

6. The method of claim 3 wherein the value of the fractional token is further dependent on a message type of the incoming message.

7. The method of claim 1 wherein the value of the fractional token has a variable value dependent on a message type of the incoming message.

8. A message throttler comprising:
a message queue; and
an admission processor to manage said message queue, said admission processor operative to:
add a fractional token to a current token count to compute a new token count responsive to arrival of an incoming message at a message queue; and
admit an outgoing message from the message queue in response to said arrival of said incoming message if the new token count satisfies a threshold.

9. The message throttler of claim 8 wherein the admission processor decrements the token count when an outgoing message is admitted.

10. The message throttler of claim 8 wherein the admission processor assigns the fractional token a variable value dependent on an indicated load of the processor.

11. The message throttler of claim 10 wherein the admission processor receives a desired admission percentage and determines the value of said fractional token based on the desired admission percentage.

12. The message throttler of claim 11 wherein the admission processor assigns a value to the fractional token equal to the admission percentage.

13. The message throttler of claim 10 wherein the admission processor assigns a value to the fractional token that is further dependent on message type of the incoming message.

14. The message throttler of claim 8 wherein the admission processor assigns a value to the fractional token that is dependent on message type of the incoming message.

15. A method of admitting messages to a processor comprising:
adding a fractional token to a token bank to compute a new token count responsive to arrival of an incoming message at a message queue; and
admitting messages from said message queue based on said token count such that admission rate is proportional to an incoming message rate.

16. The method of claim 15 further comprising decrementing the token count when an outgoing message is admitted.

17. The method of claim 15 wherein the fractional token has a variable value dependent on an indicated load of the processor.

18. The method of claim 17 further comprising computing a desired admission percentage based on the indicated load, and determining the value of said fractional token based on the desired admission percentage.

19. The method of claim 18 wherein the value of the fractional token equals the admission percentage.

20. The method of claim 17 wherein the value of the fractional token is further dependent on a message type of the incoming message.

21. The method of claim 15 wherein the value of the fractional token has a variable value dependent on a message type of the incoming message.

22. A network node in a communication network having one or more processors for processing messages comprising:
a load detector to monitor the load on one or more processors at said network node and to generate a load indication;
a load controller to detect an overload condition based on the load indication from the load detector; and
an admission controller including at least one message throttler and responsive to the load controller to control admission of new message in one or more message streams when an overload condition exists, said message throttler operative to:
add a fractional token to a current token count responsive to arrival of each incoming message at a message queue to compute a new token count; and
admit an outgoing message from the message queue responsive to the arrival of said incoming message if the new token count satisfies a threshold.

23. The network node of claim 22 wherein the load detector monitors the instantaneous load of said processors and computes a filtered load estimate for each processor.

24. The network node of claim 23 wherein the load indication is determined based on the filtered load estimates.

25. The network node of claim 22 wherein the load indication is the filtered load estimate for a selected one of said processors.

26. The network node of claim 22 wherein the admission controller comprises a plurality of message throttlers, each controlling the flow of messages in a respective message stream.

27. The network node of claim 26 wherein each message throttler admits the same ratio of incoming messages.

28. The network node of claim 22 wherein the message throttler controls admission of messages into the network node such that the ratio of admitted message to incoming messages over a control period equals a desired admission percentage.

29. The network node of claim 22 wherein the message throttler is further operative to decrement the token count when an outgoing message is admitted.

30. The method of claim 29 wherein the message throttler assigns a variable value dependent on a desired admission percentage.

31. The method of claim 30 wherein the value of the fractional token equals the admission percentage.

32. The method of claim 30 wherein the value of the fractional token is further dependent on a message type of the incoming message.

33. The method of claim 29 wherein the message throttler assigns a variable value to the fractional token dependent on a message type of the incoming message.

34. A method of controlling the load for a network node in a communication network, comprising;
monitoring the load on one or more processors at said network node and generating a load indication indicative of the load;
detecting an overload condition based on the load indication; and
controlling the admission of new messages in one or more message streams when an overload condition is detected, wherein controlling the admission of new messages comprises:
adding a fractional token to a current token count responsive to arrival of each incoming message at a message queue to compute a new token count; and
admitting an outgoing message from the message queue responsive to the arrival of said incoming message if the new token count satisfies a threshold.

35. The method of claim 34 wherein monitoring the load on one or more processors comprises monitoring the instantaneous load and computing a filtered load estimate for each processor.

36. The method of claim 35 wherein generating a load indication comprise determining the maximum filtered load estimate among all processors.

37. The method of claim 35 wherein controlling the admission of new messages comprises controlling the flow of messages in each message stream such that the same ratio of incoming messages are admitted for each stream.

38. The method of claim 35 wherein controlling the admission of new messages further comprises admitting new messages such that the ratio of admitted messages to incoming messages over a control period equals a desired admission percentage.

39. The method of claim 35 wherein controlling the admission of new messages further comprises decrementing the token count when an outgoing message is admitted.

40. The method of claim 35 wherein the fractional tokens have a variable value dependent on a desired admission percentage.

41. The method of claim 40 wherein the value of the fractional token equals the admission percentage.

42. The method of claim 40 wherein the value of the fractional token is further dependent on a message type of the incoming message.

43. The method of claim 35 wherein the fractional tokens have a variable value dependent on a message type of the incoming message.
